(19) United States
(12) Patent Application Publication
(10) Pub. No.: US 2019/0360220 A1
(43) Pub. Date: Nov. 28, 2019

(54) REINFORCING BAR PLACEMENT ANGLE SPECIFYING METHOD, REINFORCING BAR PLACEMENT ANGLE SPECIFYING SYSTEM, AND RECORDING MEDIUM THAT RECORDS REINFORCING BAR PLACEMENT ANGLE SPECIFYING PROGRAM

(71) Applicant: Olympus Corporation, Tokyo (JP)

(72) Inventors: Kenji INOSE, Tokyo (JP); Naoyuki Akiyama, Tokyo (JP); Toshiki Miyano, Yokohama (JP)

(21) Appl. No.: 16/537,475

(22) Filed: Aug. 9, 2019

Related U.S. Application Data
(63) Continuation of application No. PCT/JP2018/005093, filed on Feb. 14, 2018.

(30) Foreign Application Priority Data
Feb. 15, 2017 (JP) 2017-026486

(51) Int. Cl. E04G 21/12; G01B 11/26; G06T 7/70

(52) U.S. Cl. CPC E04G 21/12; G06T 7/70; G01B 11/26

(57) ABSTRACT

A reinforcing bar placement angle specifying method generates an orthographic image of a reinforcing bar placed on a plane from among plural reinforcing bars placed on the basis of an image of the plural reinforcing bars placed, tentatively specifies a placement state of the reinforcing bar placed on the plane by analyzing the orthographic image, and specifies a placement angle of the reinforcing bar for each reinforcing bar of which the placement state is tentatively specified.

### CROSS-REFERENCE TO RELATED APPLICATIONS

This application is based upon and claims the benefit of priority of the prior Japanese Patent Application No. 2017-026486, filed Feb. 15, 2017, the entire contents of which are incorporated herein by reference.

This is a Continuation Application of PCT Application No. PCT/JP2018/005093, filed Feb. 14, 2018, which was not published under PCT Article 21(2) in English.

### FIELD

The embodiments relate to a reinforcing bar placement angle specifying method, a reinforcing bar placement angle specifying system, and a recording medium that records a reinforcing bar placement angle specifying program.

### BACKGROUND

In constructing a reinforced concrete building, reinforcement inspection has been performed to check whether reinforcing bars are correctly placed in accordance with bar placement drawings etc. For this reinforcement inspection, a system that assists the reinforcement inspection (hereinafter referred to as “reinforcement inspection assisting system”) has been considered in view of efficiency of the inspection and reduction of inspector's workload. As an example of a reinforcement inspection assisting system, a reinforcement information acquisition system has been known in which whether a building as built is correct or not is determined by capturing an image of a part to be captured such as a pillar including reinforcing bars by a digital camera, loading the captured image into a portable terminal and generating reinforcement information, and comparing and checking the reinforcement information with design information received from a management server (see Japanese Laid-open Patent Publication No. 2013-15452).

In other examples of the reinforcement inspection assisting systems that have been known, as a step of processing to obtain reinforcement information of reinforcing bars to be inspected (such as the size and the intervals), a system performs processing for generating a three-dimensional image from a stereo image captured by a stereo camera, and another system performs processing for generating an orthographic image by means of an orthographic transformation (projective transformation) of an image.

### SUMMARY

An aspect of the embodiments is a reinforcing bar placement angle specifying method that generates an orthographic image of a reinforcing bar placed on a plane from among plural placed reinforcing bars on the basis of an image of the plural reinforcing bars placed, tentatively specifies a placement state of the reinforcing bar placed on the plane by analyzing the orthographic image, and specifies a placement angle of the reinforcing bar for each reinforcing bar of which the placement state is tentatively specified.

Another aspect of the embodiments is a reinforcing bar placement angle specifying system having an arithmetic device. The arithmetic device executes processing of obtaining an image of plural reinforcing bars placed, generating an orthographic image of a reinforcing bar placed on a plane from among the placed reinforcing bars on the basis of the image, tentatively specifying a placement state of the reinforcing bar placed on the plane by analyzing the orthographic image, and specifying a placement angle of the reinforcing bar for each reinforcing bar of which the placement state is tentatively specified.

Another aspect of the embodiments is a non-transitory computer-readable recording medium recording a reinforcing bar placement angle specifying program that causes a computer to execute processing of obtaining an image of plural reinforcing bars placed, generating an orthographic image of a reinforcing bar placed on a plane from among the placed reinforcing bars on the basis of the image, tentatively specifying a placement state of the reinforcing bar placed on the plane by analyzing the orthographic image, and specifying a placement angle of the reinforcing bar for each reinforcing bar of which the placement state is tentatively specified.

### BRIEF DESCRIPTION OF DRAWINGS

FIG. 1 is a diagram illustrating an example of the configuration of a reinforcing bar placement angle specifying system according to the first embodiment;

FIG. 2 is a diagram illustrating an example of a hardware configuration of a terminal device;

FIG. 3 is a functional block diagram of the reinforcing bar placement angle specifying system according to the first embodiment;

FIG. 4 is a flowchart illustrating an overall flow of processing of a reinforcing bar placement specifying function in the reinforcing bar placement angle specifying system according to the first embodiment;

FIG. 5 is a flowchart illustrating a flow of reinforcing bar placement specifying processing (step S801);

FIG. 6 is a flowchart illustrating a flow of processing to specify placement angles of reinforcing bars (step S810);

FIG. 7 is a flowchart illustrating a flow of processing to specify placement positions of reinforcing bars (step S830);

FIG. 8 is a diagram illustrating an example of a stereo image;

FIG. 9 is a diagram illustrating an example of a left-eye viewpoint three-dimensional image;

FIG. 10 is a diagram illustrating an example of a plane region image;

FIG. 11 is a diagram illustrating an example of a transformed orthographic plane region image;

FIG. 12 is a diagram explaining an example of reinforcing bar placement tentatively specifying information obtained by reinforcing bar placement tentatively specifying processing (step S601);

FIG. 13 is a diagram explaining an example (1) of processing when the processing in step S813 to the processing in step S815 are performed;

FIG. 14 is a diagram explaining an example (2) of processing when the processing in step S813 to the processing in step S815 are performed;

FIG. 15 is a diagram explaining an example (3) of processing when the processing in step S813 to the processing in step S815 are performed;

FIG. 16 is a diagram explaining an example of a modification of processing to extract a rectangular region image according to the first embodiment;

FIG. 17 is a diagram explaining an example of processing to generate a histogram of the rectangular region image in the lateral direction;

FIG. 18 is a functional block diagram of a reinforcing bar placement angle specifying system according to the second embodiment;

FIG. 19 is a flowchart illustrating an overall flow of the processing of a reinforcing bar placement specifying function in the reinforcing bar placement angle specifying system according to the second embodiment;

FIG. 20 is a flowchart illustrating a flow of reinforcing bar placement specifying processing (step S901);

FIG. 21 is a flowchart illustrating a flow of processing to specify a placement angle and a placement position of a reinforcing bar (step S910);

FIG. 22 is a diagram explaining an example (1) of processing when the processing in step S913 to the processing in step S915 are performed;

FIG. 23 is a diagram explaining an example (2) of processing when the processing in step S913 to the processing in step S915 are performed;

FIG. 24 is a diagram explaining an example (3) of processing when the processing in step S913 to the processing in step S915 are performed;

FIG. 25 is a diagram explaining an example of a modification of processing to extract a rectangular region image according to the second embodiment;

FIG. 26 is a diagram illustrating an example of a graph plotting values of a function f at positions in the x-direction of a rectangular region image;

FIG. 27 is a diagram illustrating an example in which the sum of values of the function f at two positions in the x-direction of the rectangular region image becomes the maximum;

FIG. 28 is a flowchart illustrating a flow of reinforcing bar placement specifying processing (step S901) according to a modification example;

FIG. 29 is a flowchart illustrating a flow of processing to specify placement angle of a reinforcing bar (step S1010) and

FIG. 30 is a flowchart illustrating a flow of reinforcing bar placement specifying processing (step S901) according to another modification example.

### DESCRIPTION OF EMBODIMENTS

In conventional reinforcement inspection assisting systems, when the above-described processing for generating a three-dimensional image is performed, three-dimensional information of a portion of the generated three-dimensional image may be absent because of a low degree of three-dimensional reconstruction accuracy. When the above-described processing for generating an orthographic image is performed, because of a low degree of estimation accuracy of an orthographic transformation matrix used in an orthographic transformation, plural reinforcing bars represented in the generated orthographic image that should be parallel to one another may not appear parallel to one another. Or, the plural reinforcing bars that should be placed in parallel may not be placed in parallel.

In this case, conventional reinforcement inspection assisting systems may not be able to obtain reinforcement information with a high degree of accuracy because such systems are unable to specify, with a high degree of accuracy, a placement angle of each of plural reinforcing bars to be inspected.

In the light of the above-described circumstances, the embodiments described hereafter provide a method, a system, and a recording medium recording a program that enables highly accurate specification of a placement angle of each of plural reinforcing bars to be inspected.

In the following description, the present embodiments are explained with reference to the drawings.

### First Embodiment

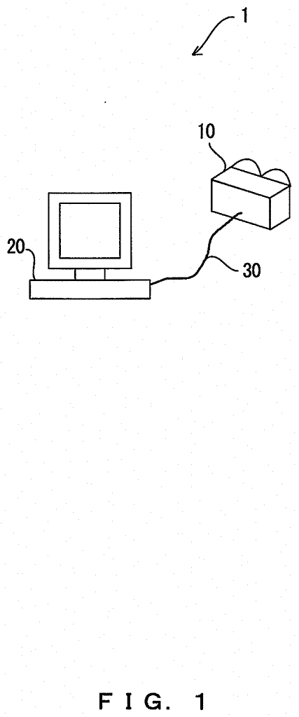

FIG. 1 is a diagram illustrating an example of the configuration of a reinforcing bar placement angle specifying system according to the first embodiment. Note that the reinforcing bar placement angle specifying system is an example of a reinforcement inspection assisting system.

As illustrated in FIG. 1, a reinforcing bar placement angle specifying system 1 includes a stereo camera 10 and a terminal device 20, which are coupled to communicate with each other via a cable 30. The stereo camera 10 and the terminal device 20 may be coupled to communicate with each other via radio waves.

The stereo camera 10 obtains (generates) a stereo image by capturing plural reinforcing bars to be inspected. The stereo image is formed from two images captured from two viewpoints of the stereo camera 10. The two viewpoints of the stereo camera 10 include a left-eye viewpoint corresponding to a left eye and a right-eye viewpoint corresponding to a right eye. In the following description, an image captured from the left-eye viewpoint is referred to as a left-eye viewpoint image and an image captured from the right-eye viewpoint is referred to as a right-eye viewpoint image. A stereo image (a left-eye viewpoint image and a right-eye viewpoint image) may consist of color images or may consist of multi-tone monochrome images such as gray scale images. However, the stereo image in the present embodiment consists of gray scale images. The stereo camera 10 obtains (generates) a three-dimensional image (an image having three-dimensional information) of left-eye viewpoint or right-eye viewpoint from the obtained stereo image.

The terminal device 20 performs processing to specify placement (angle and position) of each of reinforcing bars captured by the stereo camera 10 based on an image and a three-dimensional image of the same viewpoint (left-eye viewpoint or right-eye viewpoint) obtained by the stereo camera 10 (hereinafter referred to as “reinforcing bar placement specifying processing”). In the present embodiment, the reinforcing bar placement specifying processing is performed according to an image and a three-dimensional image of left-eye viewpoint obtained by the stereo camera 10, but the reinforcing bar placement specifying processing may be performed according to an image and a three-dimensional image of right-eye viewpoint. The terminal device 20 also performs processing such as processing to obtain (measure) reinforcement information such as the size, the number, and the intervals of the reinforcing bars based on the placement of each of the reinforcing bars specified by the reinforcing bar placement specifying processing and processing to display and to record the result of the above processing. The terminal device 20 is a PC (Personal Computer) or a tablet terminal as an example.

The cable 30 can be attached to and detached from the stereo camera 10 and the terminal device 20. The cable 30 is a USB (Universal Serial Bus) cable as an example.

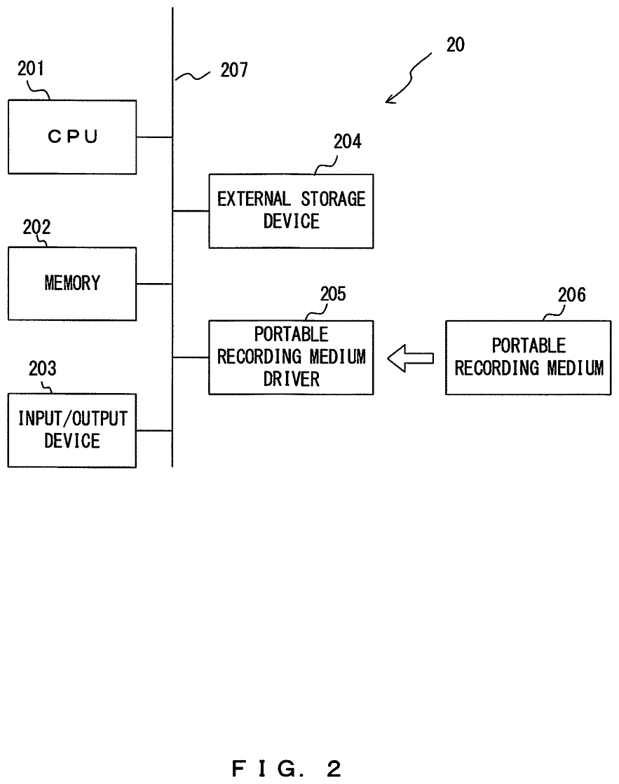

FIG. 2 is a diagram illustrating an example of a hardware configuration of the terminal device 20.

As illustrated in FIG. 2, the terminal device 20 includes CPU (Central Processing Unit) 201, a memory 202, an input/output device 203, an external storage device 204, and a portable recording media driver 205 in which a portable recording medium 206 is loaded. CPU 201, the memory 202, the input/output device 203, the external storage device 204, and the portable recording media driver 205 are coupled to each other via a bus 207.

CPU 201 is an arithmetic device that executes programs for processing (including the reinforcing bar placement specifying processing) conducted by the terminal device 20. The memory 202 is, for example, RAM (Random Access Memory) and ROM (Read Only Memory) and RAM may be used as a work area of CPU 201 and ROM may store programs and information that is needed to execute the programs in a non-volatile manner.

The input/output device 203 is an interface device for exchanging information with other devices such as the stereo camera 10, a display device, a keyboard, a mouse, and a printer.

The external storage device 204 is a storage that stores programs, information that is needed to execute the programs, information obtained from the execution of the programs, and others in a non-volatile manner. The external storage device 204 is a hard disk device for example. The portable recording media driver 205 is a device for loading the portable recording medium 206 which includes an optical disk and a CompactFlash™. The portable recording medium 206 is, like the external storage device 204, a storage that stores programs, information that is needed to execute the programs, information obtained from the execution of the programs, and others in a non-volatile manner.

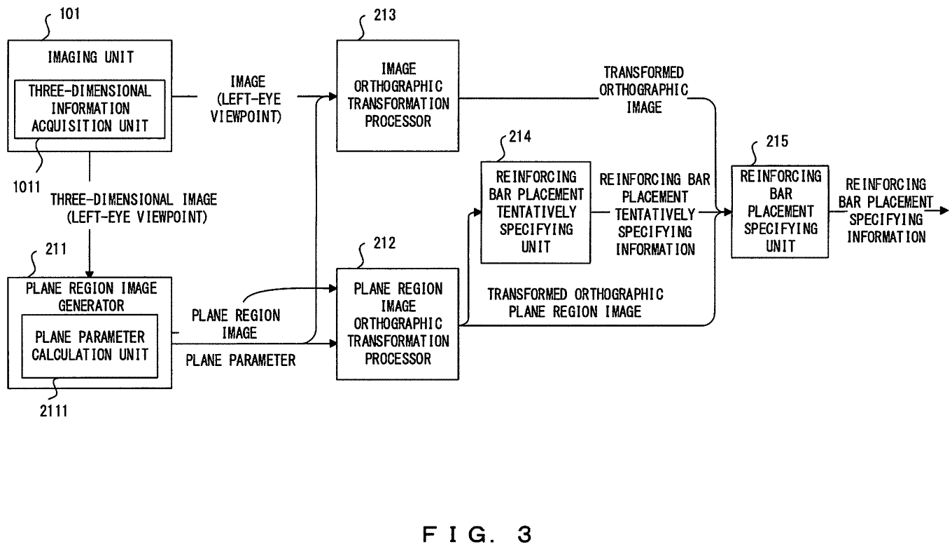

FIG. 3 is a functional block diagram of the reinforcing bar placement angle specifying system 1. Note that FIG. 3 illustrates only a functional block that relates to a reinforcing bar placement specifying function (a function to specify reinforcing bar placement) in the reinforcing bar placement angle specifying system 1.

As illustrated in FIG. 3, the reinforcing bar placement angle specifying system 1 includes an imaging unit 101, a plane region image generator 211, a plane region image orthographic transformation processor 212, an image orthographic transformation processor 213, a reinforcing bar placement tentatively specifying unit 214, and a reinforcing bar placement specifying unit 215.

Note that the imaging unit 101 corresponds to a functional block in the stereo camera 10. The plane region image generator 211, the plane region image orthographic transformation processor 212, the image orthographic transformation processor 213, the reinforcing bar placement tentatively specifying unit 214, and the reinforcing bar placement specifying unit 215 correspond to functional blocks in the terminal device 20.

The imaging unit 101 captures an image of plural reinforcing bars to be inspected, obtains (generates) a stereo image (a left-eye viewpoint image and a right-eye viewpoint image), and outputs the left-eye viewpoint image to the image orthographic transformation processor 213. The imaging unit 101 includes a three-dimensional information acquisition unit 1011. The three-dimensional information acquisition unit 1011 obtains (generates) a left-eye viewpoint three-dimensional image from the obtained stereo image and outputs the generated image to the plane region image generator 211.

The plane region image generator 211 includes a plane parameter calculation unit 2111. The plane parameter calculation unit 2111 calculates (estimates) plane parameters (coefficients) in a plane equation that represents a plane in which the placed reinforcing bars are included from the left-eye viewpoint three-dimensional image from the imaging unit 101. The plane parameter calculation unit 2111 outputs the calculated parameters to the plane region orthographic transformation processor 212 and the image orthographic transformation processor 213. The plane region image generator 211 generates a plane region image from the left-eye viewpoint three-dimensional image input from the imaging unit 101 by using the plane parameters calculated by the plane parameter calculation unit 2111 and outputs the plane region image to the plane region image orthographic transformation processor 212.

The plane region image orthographic transformation processor 212 performs orthographic transformation to the plane region image from the plane region image generator 211 and outputs the processed plane region image (hereinafter referred to as “transformed orthographic plane region image”) to the reinforcing bar placement tentatively specifying unit 214 and the reinforcing bar placement specifying unit 215. Note that the processing of orthographic transformation executed here is processing of projective transformation that causes a plane represented by the plane equation of the plane parameters from the plane region image generator 211 to be in parallel with the plane captured from the left-eye viewpoint of the stereo camera 10. The transformed orthographic plane region image is also an orthographic image generated with respect to the left-eye viewpoint three-dimensional image.

The image orthographic transformation processor 213 performs orthographic transformation similar to the above processing on the left-eye viewpoint image from the imaging unit 101 and outputs the processed left-eye viewpoint image (hereinafter referred to as “transformed orthographic image”) to the reinforcing bar placement specifying unit 215. The transformed orthographic image is also an orthographic image generated with respect to the left-eye viewpoint image.

The reinforcing bar placement tentatively specifying unit 214 analyzes the transformed orthographic plane region image input from the plane region image orthographic transformation processor 212, obtains reinforcing bar placement tentatively specifying information that is provisional placement information of each of the reinforcing bars, and outputs the information to the reinforcing bar placement specifying unit 215.

The reinforcing bar placement specifying unit 215 obtains reinforcing bar placement specifying information, which is more accurate placement information of each of the reinforcing bars, based on the transformed orthographic plane region image input from the plane region image orthographic transformation processor 212, the transformed orthographic image input from the image orthographic transformation processor 213, and the reinforcing bar placement tentatively specifying information input from the reinforcing bar placement tentatively specifying unit 214.

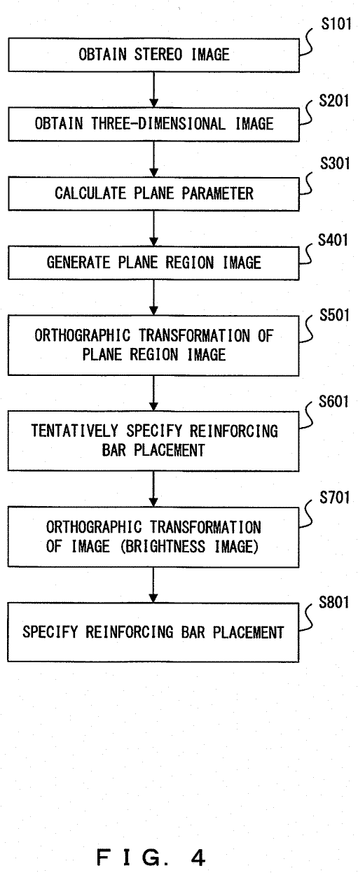

Next, a flow of the processing of the reinforcing bar placement specifying function in the reinforcing bar placement angle specifying system 1 is explained in detail with reference to FIG. 4 to FIG. 17.

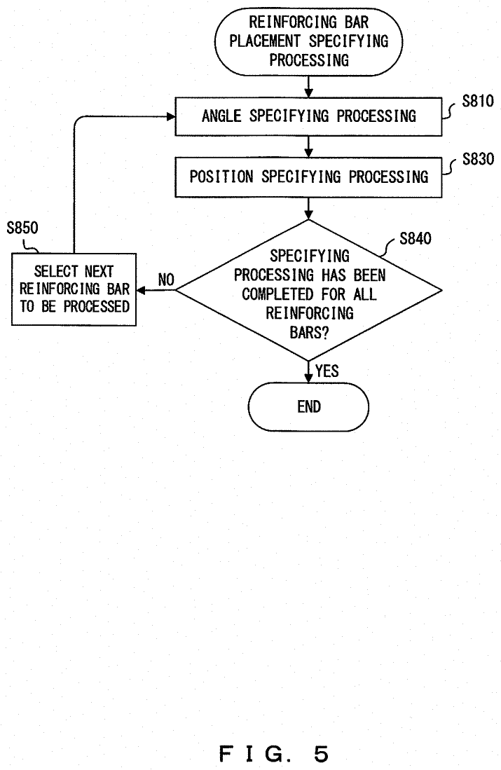

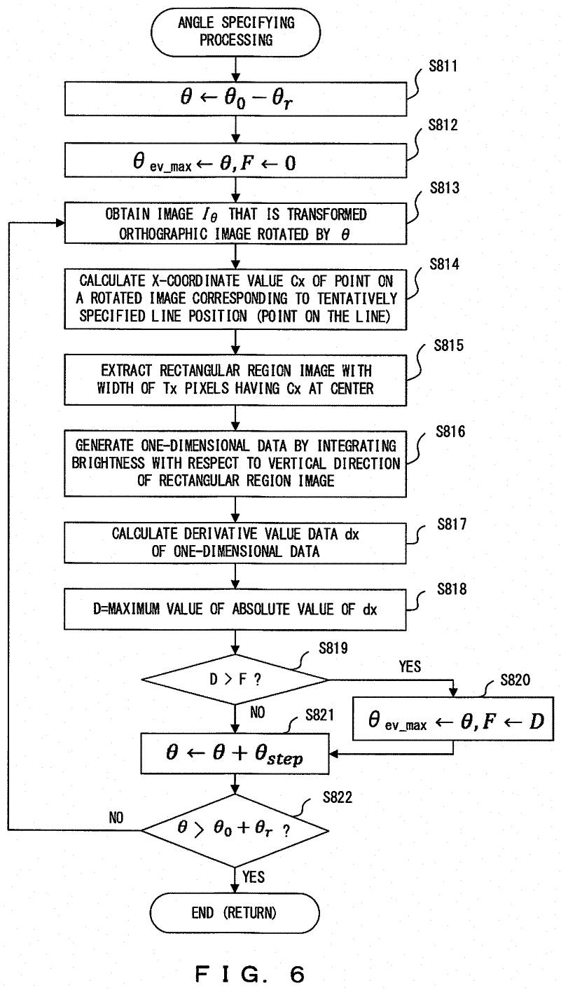

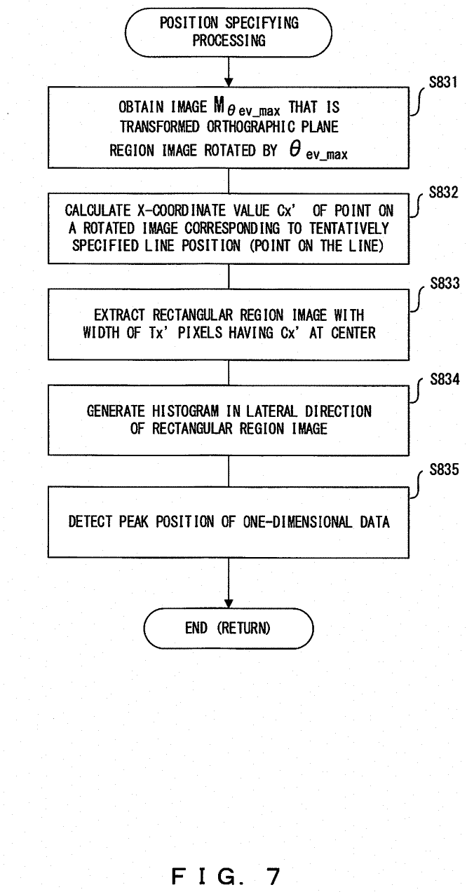

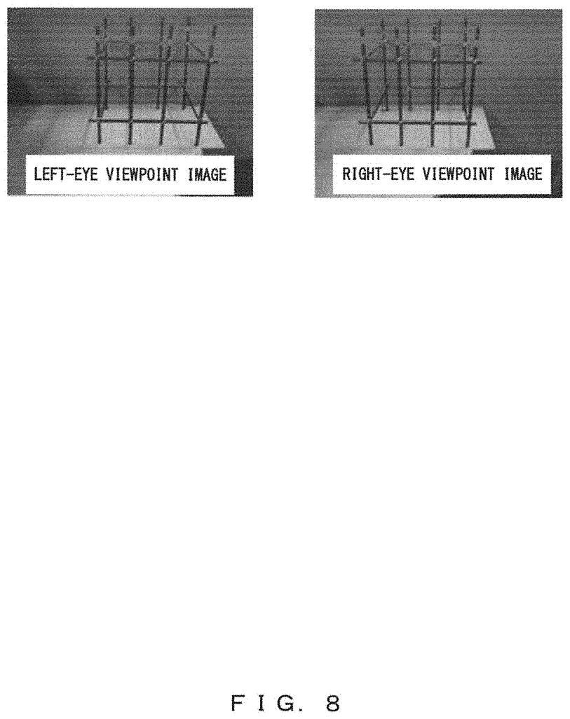

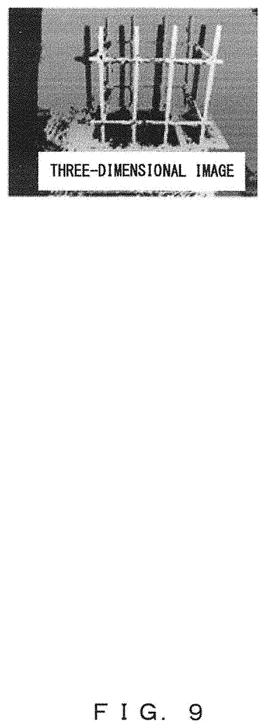

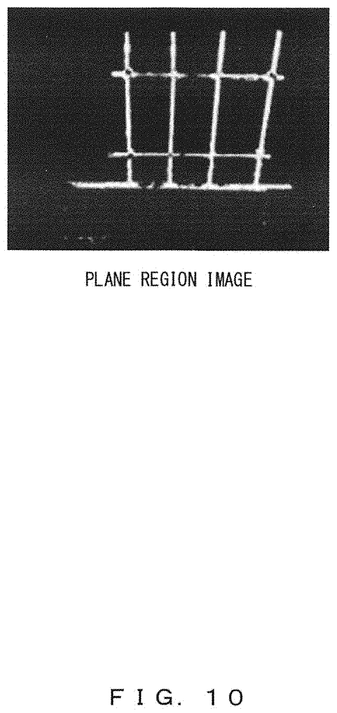

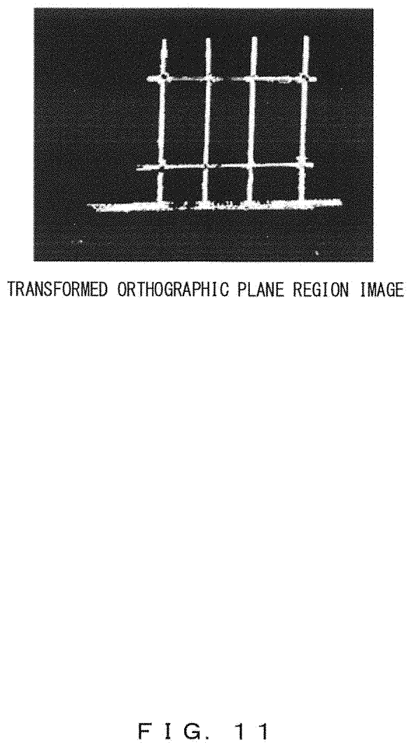

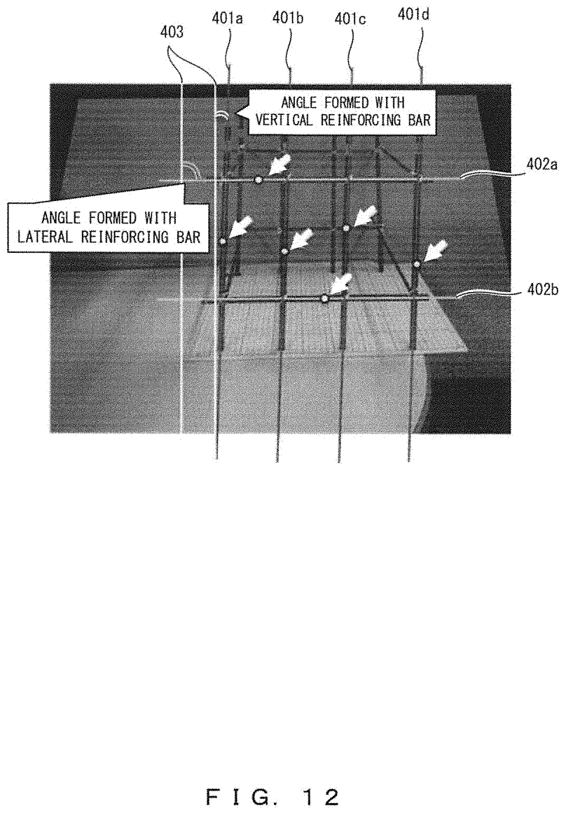

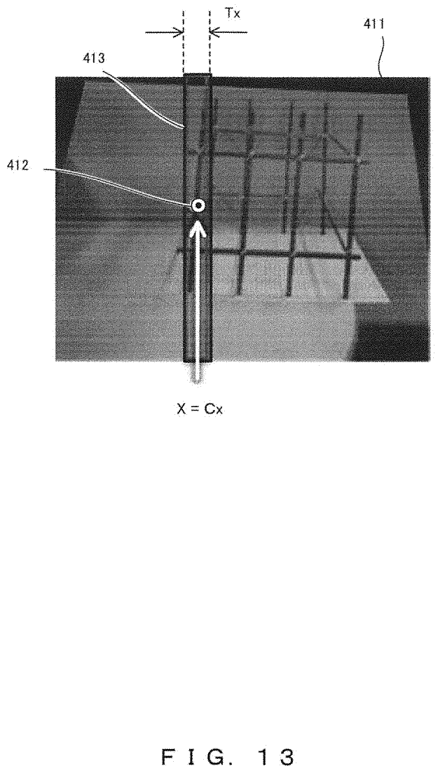

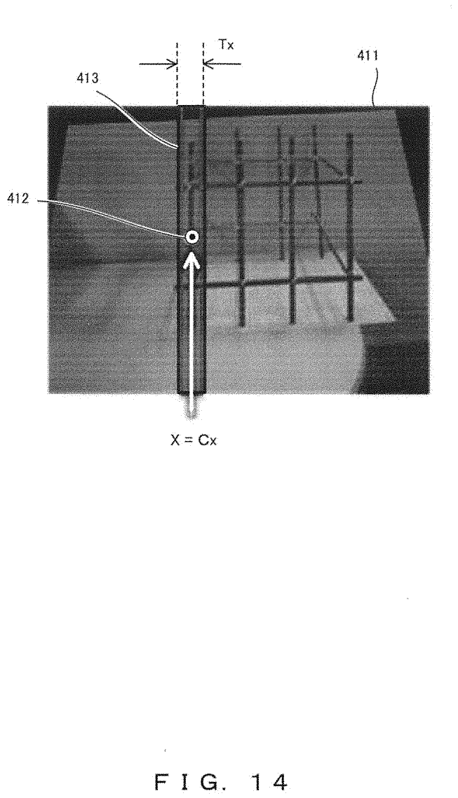

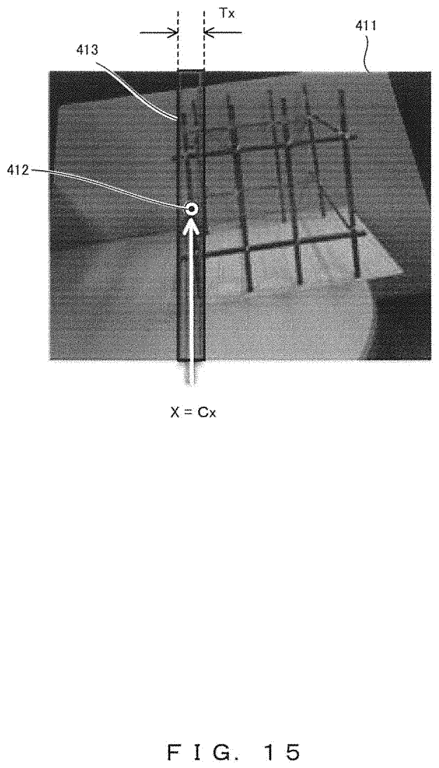

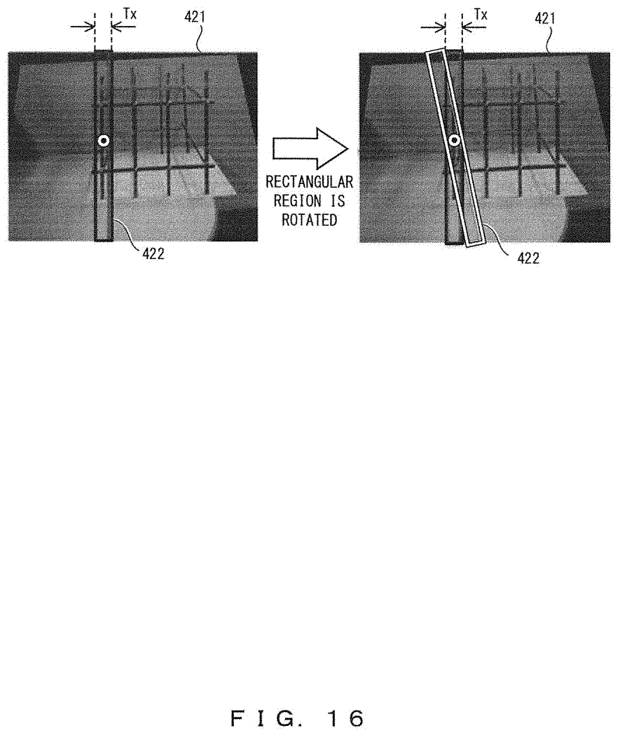

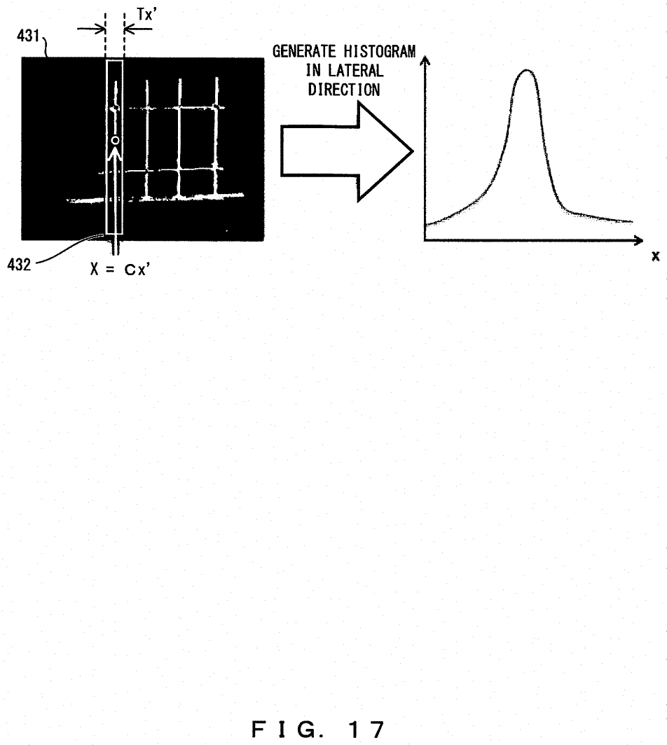

FIG. 4 is a flowchart illustrating an overall flow of the processing. FIG. 5 is a flowchart illustrating a flow of reinforcing bar placement specifying processing (step S801 described later). FIG. 6 is a flowchart illustrating a flow of processing to specify placement angles of reinforcing bars (step S810 described later). FIG. 7 is a flowchart illustrating a flow of processing to specify placement positions of reinforcing bars (step S830 described later). FIG. 8 is a diagram illustrating an example of a stereo image. FIG. 9 is a diagram illustrating an example of a left-eye viewpoint three-dimensional image. FIG. 10 is a diagram illustrating an example of a plane region image. FIG. 11 is a diagram illustrating an example of a transformed orthographic plane region image. FIG. 12 is a diagram explaining an example of reinforcing bar placement tentatively specifying information obtained by reinforcing bar placement tentatively specifying processing (step S601 described later). FIG. 13, FIG. 14, and FIG. 15 are diagrams explaining an example of processing when the processing in step S813 to the processing in step S815, which are described later, are repeated. FIG. 16 is a diagram explaining an example of a modification of processing to extract a rectangular region image. FIG. 17 is a diagram explaining an example of processing to generate a histogram of the rectangular region image in the lateral direction.

As illustrated in FIG. 4, in the processing of the reinforcing bar placement specifying function of the reinforcing bar placement angle specifying system 1, in step 101, the stereo camera 10 captures an image of plural reinforcing bars to be inspected and obtains (generates) a stereo image (a left-eye viewpoint image and a right-eye viewpoint image) as illustrated in FIG. 8. Note that in this processing, the plural reinforcing bars to be inspected are plural reinforcing bars placed in both vertical and lateral directions as illustrated in FIG. 8.

In step S201, the stereo camera 10 performs known stereo matching processing of the obtained stereo image and thereby obtains (generates) a left-eye viewpoint three-dimensional image (an image having three-dimensional information) as illustrated in FIG. 9. Note that the three-dimensional image is also referred to as a depth map or a distance image. In the three-dimensional image illustrated in FIG. 9, the distance from the stereo camera 10 is expressed by brightness scale values in such a manner that objects closer to the stereo camera 10 appear whiter and objects farther away from the stereo camera 10 appear darker black. Note that regions for which three-dimensional information could not be obtained are expressed in black. The regions for which three-dimensional information could not be obtained include, for example, a region of which an image has been captured from only one viewpoint, a region with no patterns, and a region in which a pattern is repeated.

In step S301, CPU 201 of the terminal device 20 detects a plane in which placed reinforcing bars are included from the left-eye viewpoint three-dimensional image obtained by the stereo camera 10 in step S201. Note that this detection also calculates (estimates) plane parameters (coefficients) in a plane equation that represents the plane. The plane equation is given as the following formula (1).

ax+by+cz+d=0 Formula (1)

Here, (x, y, z) indicates a coordinate of a point in a three-dimensional space and coefficients a, b, c, and d indicate plane parameters in the plane equation. These plane parameters can be calculated by using any known art such as the least squares method.

In step S401, CPU 201 generates a plane region image as illustrated in FIG. 10 from the left-eye viewpoint three-dimensional image obtained by the stereo camera 10 in S201 by using the plane parameters calculated in step S301. The plane region image is a binary image of the left-eye viewpoint three-dimensional image in which pixels included in a plan region represented by the plane equation of the calculated plane parameters are represented by 1 and pixels that are not included in the plane region are represented by 0. A determination of whether a pixel is included in the plane region or not can be made by using the following formula (2).

when |ax+by+cz+d|<Dₜₕᵣ, Mₚₗₐₙₑ(u,v)=1

otherwise Mₚₗₐₙₑ(u,v)=0 Formula (2)

Here, (x, y, z) indicates a coordinate of a point in a three-dimensional space corresponding to a pixel (u,v) of the generated plane region image Mₚₗₐₙₑ. Dₜₕᵣ is a threshold relating to a distance from the plane region represented by the plane equation. According to the above formula (2), when the distance from the plane region is shorter than Dₜₕᵣ, a pixel is determined to be included in the plane region (=1), and otherwise a pixel is determined to be not included in the plane region (=0). Note that a region in which three-dimentional information could not be obtained in the three-dimensional image obtained in S201 is determined to be not included in the plane region (=0).

In step S501, CPU 201 performs the orthographic transformation of the plane region image generated in step S401 and a transformed orthographic plane region image is generated (obtained). Note that the orthographic transformation executed here is processing of projective transformation that causes a plane represented by the plane equation of the plane parameters calculated in step S401 to be in parallel with the plane captured from the left-eye viewpoint of the stereo camera 10. In other words, the orthographic transformation is projective transformation processing that makes the plane detected in step S301 be parallel to the plane captured from the left-eye viewpoint. As a reuslt, an image that appears as if the plane detected in step S301 was captured from the frontal side can be obtained. For example, for the plane region image illustrated in FIG. 10, a transformed orthographic plane region image illustrated in FIG. 11 can be obtained. Accordingly, the plural reinforcing bars paralell to each other in a three-dimensional space are represented in parallel on the transformed orthographic plane region image.

Note that the projective transformation is processing to convert a coordinate value of a given coordinate system into a coordinate value of another coordinate system, and the orthographic transformation is one type of the projective transformation. At that time, the coordinate transformation formula is expressed by the following formula (3) by using a matrix.

(x1,y1,1)^{T}=H·(x2,y2,1)^{T} Formula (3)

Here, H is a 3×3 matrix, (x1, y1) is a transformed coordinate value, and (x2, y2) is an original coordinate value. The matrix H can be estimated by using any known arts such as a method in which the matrix is obtained from a rotational component between planes (a component of an angular difference between a plane in which placed reinforcing bars are included and a plane captured from the left-eye viewpoint of the stereo camera 10) and a method of estimating a matrix by means of optimization by the least squares method etc. based on four or more sets of corresponding points between two planes.

In step S601, CPU 201 performs the reinforcing bar placement tentatively specifying processing in which the vertical and lateral axes of reinforcing bars and positions of reinforcing bars are obtained by known histogram analysis etc. of the transformed orthographic plane region image obtained in step S501. As a result, tentative placement information of reinforcing bars (reinforcing bar placement tentatively specifying information) is obtained as angles of lines (axes of the detected bars) and positions (arbitrary points through which the lines pass) of the lines. More specifically, the reinforcing bar placement tentatively specifying information obtained in S601 includes information relating to an angle formed by the vertical axis of the image coordinate system and a vertical axis of the detected reinforcing bar for each of the vertical axes of the detected reinforcing bars (axes of vertical reinforcing bars), information relating to an angle formed by the vertical axis of the image coordinate system and a lateral axis of the detected reinforcing bar for each of the lateral axes of the detected reinforcing bars (axes of lateral reinforcing bars), and information relating to a position of an arbitrary point through which an axis passes for each of axes of the detected reinforcing bars. In other words, the reinforcing bar placement tentatively specifying information includes information relating to an angle formed by a reinforcing bar axis and the vertical axis of the image coordinate system and a position of an arbitrary point through which the reinforcing bar axis passes for each of the axes of the detected reinforcing bars. For example, as illustrated in FIG. 12, when lines 401a , 401b , 401c , and 401d were detected as vertical axes of reinforcing bars and the lines 402a and 402b were detected as lateral axes of reinforcing bars, information relating to an angle formed by the line 401a and a vertical axis 403 of the image coordinate system (i.e., an angle of line 401a ), an angle formed by the line 402a and the vertical axis 403 of the image coordinate system (i.e., an angle of line 402a ), and arbitrary points (points indicated by arrows) through which the lines 401a , 401b , 401c , 401d , 402a , and 402b pass respectively are obtained as reinforcing bar placement tentatively specifying information. Note that in FIG. 12, a transformed orthographic image corresponding to a transformed orthographic plane region image is used for the convenience of description.

In step S701, CPU 201 generates (obtains) a transformed orthographic image by means of the orthographic transformation similar to step S501 performed on a left-eye viewpoint image (a brightness image) obtained by the stereo camera 10 in step S101. Note that this step S701 may be performed any time between the processing in step S301 and the processing in step S801.

In step S801, CPU 201 performs reinforcing bar placement specifying processing for obtaining reinforcing bar placement specifying information, which is more accurate placement information of reinforcing bars, based on the transformed orthographic plane region image obtained in step S501, the reinforcing bar placement tentatively specifying information obtained in step S601, and the transformed orthographic image obtained in step S701.

Here, a detailed flow of the reinforcing bar placement specifying processing (step S801) is explained with reference to FIG. 5. In the processing illustrated in FIG. 5, each of lines (reinforcing bar axes) of which information of angles and positions is included in the reinforcing bar placement tentatively specifying information obtained in step S601 is processed, and processing to specify more accurate angle and position is performed repeatedly for each of the lines to be processed.

As illustrated in FIG. 5, in step S810, CPU 201 performs angle specifying processing that specifies more accurate angles of lines to be processed according to the transformed orthographic image obtained in step S701.

Here, a detailed flow of the angle specifying processing (step S810) is explained with reference to FIG. 6. In the processing illustrated in FIG. 6, every time an angle is changed, processing of calculating an evaluation value relating to the brightness gradient and updating the maximum value of the evaluation value is repeatedly performed on the lines to be processed.

As illustrated in FIG. 6, in step S811, CPU 201 specifies θ₀−θᵣ as a starting angle for an angle θ of a line. Here, θ₀ is an angle of a line to be processed that is included in the reinforcing bar placement tentatively specifying information obtained in step S601. θᵣ is a setting value within a search range of angle. According to this setting value, the search range is θ₀±θᵣ.

In step S812, CPU 201 initializes a variable F for updating the maximum value of an evaluation value of brightness gradient and a variable θ_{ev_max} for recording an angle at which the evaluation value becomes the maximum value. In other words, the variable F is set to 0 and the variable θ_{ev_max} is set to θ.

In step S813, CPU 201 obtains a rotated image I_{θ} that is obtained by rotating a transformed orthographic image obtained in step S701 by the angle θ.

In step S814, CPU 201 obtains an x-coordinate value Cx on the rotated image Ie obtained in step S813, the x-coordinate value corresponding to a position of a line to be processed that is included in the reinforcing bar placement tentatively specifying information obtained in step S601.

In step S815, CPU 201 extracts a rectangular region image with a specific width Tx (a width of the rotated image I_{θ} in the x-direction) having the x-coordinate value Cx obtained in step S814 at the center. The width Tx is 40 pixels for example. Note that the height of the rectangular region is the same as the height of the rotated image I_{θ}. This rectangular region is also an example of a region including a reinforcing bar corresponding to a line to be processed and a surrounding region of the reinforcing bar.

When the above-described processing in steps S813 to S815 is repeated, images of a rectangular region 413 illustrated in FIG. 13, FIG. 14 and FIG. 15 are extracted as examples. Note that in each of FIG. 13, FIG. 14, and FIG. 15, an image 411 is the rotated image I_{θ} obtained in step S813. However, the angle θ that is an angle at which the transformed orthographic image is rotated in step S813 is different in each of the image 411 in FIG. 13, the image 411 in FIG. 14, and the image 411 in FIG. 15 due to the processing in step S821 described later. In each drawing, a point 412 indicates a point on the image 411. The point corresponds to a position of a line to be processed. The position is included in the reinforcing bar placement tentatively specifying information obtained in step S601. The x-coordinate value of the point is Cx. The image of the rectangular region 413 is a rectangular region image extracted in step S815 and is an image of a rectangular region with a specific width Tx having the x-coordinate value Cx of the point 412 at the center.

In step S816, CPU 201 generates one-dimensional data by integrating a brightness value with respect to the vertical direction (y-direction) in the rectangular region image extracted in step S815. This one-dimensional data is data relating to an integral value of the brightness value with respect to the vertical direction at each position in the lateral direction (x-direction) of the rectangular region image. Note that the vertical direction and the lateral direction of the rectangular region image are for example a vertical direction (y-direction) and a lateral direction (x-direction) of the image of the rectangular region 413 illustrated in FIG. 13, respectively.

In step S817, CPU 201 calculates derivative value data dx of the one-dimensional data generated in step S816. The derivative value data dx corresponds to the gradient of the sum of the brightness values.

In step S818, CPU 201 calculates absolute values of the derivative value data dx calculated in step S817 and obtains the maximum value D from among the absolute values. Here, when the absolute value of the derivative value data dx is regarded as an evaluation value, the maximum value D is the maximum value of the evaluation value at the angle θ.

In step S819, CPU 201 determines whether the maximum value D obtained in step S818 is larger than the value of the variable F or not. Here, when the determination result is YES, CPU 201 updates the variable θ_{ev_max} to the angle θ and the value of the variable F is updated to the maximum value D in step S820.

On the other hand, when the determination result in step S819 is NO, or after step S820, CPU 201 adds a step size θₛₜₑₚ to the angle θ in step S821. For example, the step size θₛₜₑₚ is 0.5 degrees.

In step S822, CPU 201 determines whether the angle θ exceeds the search range of angle (θ₀±θᵣ) or not. Here, the determination result is NO, the processing returns to step S813.

On the other hand, when the determination result in step S822 is YES, the processing returns.

According to the above-described processing illustrated in FIG. 6, a value of the variable θ_{ev_max} can be obtained as an angle of line to be processed.

Note that in the processing illustrated in FIG. 6, a transformed orthographic plane region image is rotated and a rectangular region image is extracted at each angle within the search range. However, by rotating the rectangular region instead of the transformed orthographic image, an image of the rotated rectangular region may be extracted. For example, as illustrated in FIG. 16, by rotating the rectangular region 422 instead of the transformed orthographic image 421, an image of the rotated rectangular region 422 (the rectangular region 422 in the transformed orthographic image 421 in the right side) may be extracted.

The processing illustrated in FIG. 6 can be understood as below by using mathematical formulas.

A line to be processed is set to be a baseline and the baseline is rotated by plural angles. At each of the plural angles, a prescribed rectangular region that includes the baseline is set, and within the rectangular region, a brightness gradient is calculated in a direction perpendicular to the baseline. This brightness gradient is calculated as a difference between the sum of brightness values on the baseline and the sum of brightness values on each of plural lines adjacent to and parallel to the baseline. In this manner, plural brightness gradients are calculated at every angles. An angle at which the brightness gradient becomes the maximum value is acquired and the angle is obtained as an angle of the line to be processed. When this is expressed in a mathematical formula, the following formula (4) is obtained.

$${θ}^{′} = {argmax}_{{θ}_{o} - {θ}_{r} \leq θ \leq {θ}_{o} + {θ}_{r}} ( {max}_{- ⌊ {T}_{x} / 2 ⌋ \leq x \leq ⌊ {T}_{x} / 2 ⌋} f ( x , θ ) ) \\ where f ( x , θ ) = \vert \frac{\partial \int {I}_{θ} ( x , y ) dy}{\partial x} \vert \qquad Formula ( 4 )$$

In the formula (4), θ′ is θ_{ev_max} described above. A function f is the evaluation value described above and represents a difference between the sum of brightness values on a baseline and the sum of brightness values on lines adjacent to and parallel to the baseline. θᵣ is a range of rotation angle when a baseline is rotated by plural angles. Tx is a range for calculating the brightness gradients in a direction perpendicular to the rotated baseline. ∫I_{θ}(x,y)dy, which is included in the function f, represents the sum of brightness values of pixels located on the pixel coordinate value x of the rotated image I_{θ} (the sum of brightness values on a vertical line passing through a point of the image coordinate value x).

The maximum value D calculated in step S818 is represented by the following formula (5).

$$D = {max}_{- ⌊ {T}_{x} / 2 ⌋ \leq x \leq ⌊ {T}_{x} / 2 ⌋} f ( x , {θ}^{′} ) \qquad Formula ( 5 )$$

In the above formula (5), θ′ is an angle during the repeated processing relating to angles and D is the maximum value of the evaluation value at the angle θ′.

With reference to FIG. 5, in step S830, CPU 201 performs position specifying processing that specifies a more accurate position of a line to be processed according to the transformed orthographic plane region image obtained in step S501 and the angle of the line to be processed, which is obtained in step S810.

Here, a detailed flow of the position specifying processing (step S830) is explained with reference to FIG. 7.

As illustrated in FIG. 7, in step S831, CPU 201 obtains a rotated image Mθ_{ev_max} that is a transformed orthographic plane region image obtained in step S501 being rotated by the angle θ_{ev_max} of a line to be processed, which is obtained in step S810.

In step S832, CPU 201 obtains the x-coordinate value Cx′ on the rotated image Mθ_{ev_max} obtained in step S831, the x-coordinate value corresponding to a position of a line to be processed that is included in the reinforcing bar placement tentatively specifying information obtained in step S601.

In step S833, CPU 201 extracts an image of a rectangular region with a specific width Tx′ (a width on the rotated image Mθ_{ev_max} in the x-direction) having the x-coordinate value Cx′ obtained in step S823 at the center. The width Tx′ is 40 pixels as an example. The height of the rectangular region is the height of the rotated image Mθ_{ev_max}. This rectangular region is also an example of a region including a reinforcing bar corresponding to the line to be processed and a surrounding region of the reinforcing bar.

In step S834, CPU 201 generates a histogram of the lateral direction (x-direction) with respect to the rectangular region image obtained in step S833. More specifically, similarly to step S816, CPU 201 generates one-dimensional data by integrating brightness values with respect to the vertical direction (y-direction) in the rectangular region image. This one-dimensional data is data relating to an integral value of the brightness values with respect to the vertical direction at each of positions in the lateral direction (x-direction) of the rectangular region image extracted in step S833. Here, because the brightness value of each of the pixels in the rectangular region image is either 1 or 0, this processing is based on the assumption that the integral value equals to the number of pixels with the brightness value being 1. For example, as illustrated in FIG. 17, a histogram of the number of pixels (the number of pixels with the brightness value being 1) in the x-direction of the rectangular region 432 on the rotated image Mθ_{ev_max} (a histogram of an image of the rectangular region 432 in the lateral direction) is generated.

In step S835, CPU 201 detects a peak position in the histogram generated in step S834. This detection is carried out by a method such as detecting a position at which the maximum value of the histogram is obtained as a peak position, for example.

When step S835 is ended, the processing returns.

By means of the above-described processing illustrated in FIG. 7, a peak position detected in step S835 can be obtained as a position of the line to be processed.

With reference to FIG. 5, in step S840, CPU 201 determines whether the processing in step S810 and the processing in step S830 have been completed or not for all lines (reinforcing bars) of which information of angles and positions is included in the reinforcing bar placement tentatively specifying information obtained in step S601. Here, when the determination result is NO, in step S850, CPU 201 selects a line that has not been processed from among the lines (reinforcing bars) of which information of angles and positions is included in the reinforcing bar placement tentatively specifying information as the next line to be processed, and the processing returns to step S810.

On the other hand, when the determination result in step S840 is YES, the processing ends.

As a result of the above-described processing, more accurate angles and positions of lines that is more accurate placement angles and placement positions of reinforcing bars are obtained as reinforcing bar placement specifying information.

Based on the reinforcing bar placement specifying information and the transformed orthographic image obtained in step S701 as an example, CPU 201 performs processing to obtain (measure) reinforcement information such as the size, the intervals and the number of the reinforcing bars and processing to display and record the processing result.

As described above, according to the reinforcing bar placement angle specifying system 1 according to the present embodiment, placement angles and placement positions of plural reinforcing bars to be inspected can be specified with a high degree of accuracy, and based on the placement angles and placement positions, highly accurate reinforcement information such as the size, the intervals and the number of the reinforcing bars can be obtained.

### Second Embodiment

Next, the second embodiment is described.

In the description of the second embodiment, features that are different from the first embodiments are mainly explained. Components that are the same as those in the first embodiment are assigned with the same reference numbers and the descriptions of those components are omitted.

The reinforcing bar placement angle specifying system 1 according to the second embodiment has the same configuration as the configuration illustrated in FIG. 1 and the description of the system is omitted here. The terminal device 20 according to the second embodiment has the same hardware configuration as the hardware configuration illustrated in FIG. 2 and the description of the device is omitted here.

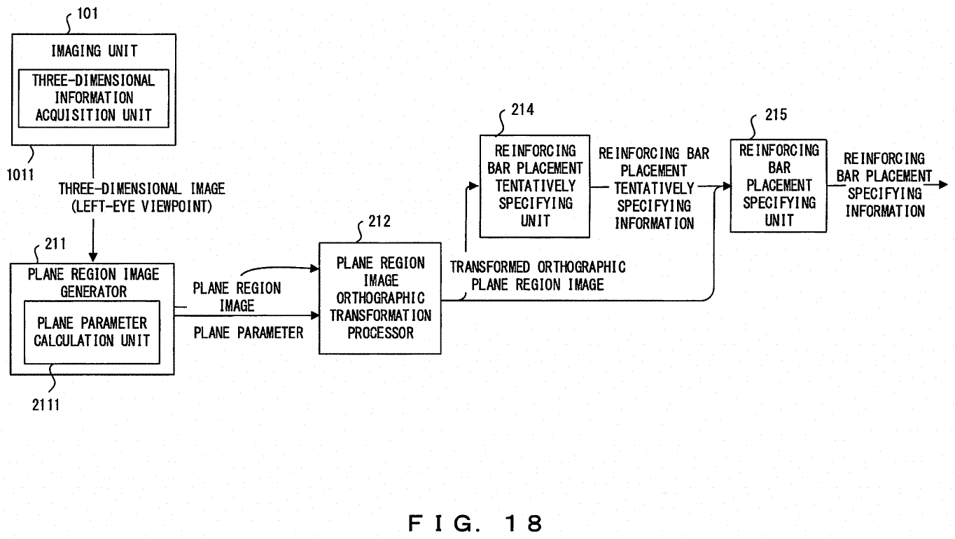

FIG. 18 is a functional block diagram of the reinforcing bar placement angle specifying system 1 according to the second embodiment. Note that FIG. 18 illustrates only a functional block that relates to a reinforcing bar placement specifying function in the reinforcing bar placement angle specifying system 1 according to the second embodiment is illustrated.

As illustrated in FIG. 18, the reinforcing bar placement angle specifying system 1 according to the second embodiment is different from the reinforcing bar placement angle specifying system 1 according to the first embodiment illustrated in FIG. 3 in such a point that the reinforcing bar placement angle specifying system 1 according to the second embodiment does not have the image orthographic transformation processor 213.

Because of this, the imaging unit 101 does not output any image. In the plane region image generator 211, the plane parameter calculation unit 2111 outputs the calculated plane parameters only to the plane region image orthographic transformation processor 212. The reinforcing bar placement specifying unit 215 obtains reinforcing bar placement specifying information, which is more accurate placement information of reinforcing bars, based on the transformed orthographic plane region image input from the plane region image orthographic transformation processor 212 and the reinforcing bar placement tentatively specifying information input from the reinforcing bar placement tentatively specifying unit 214.

Other functional blocks in FIG. 18 are the same as the functional blocks illustrated in FIG. 3 and the descriptions of those blocks are omitted here.

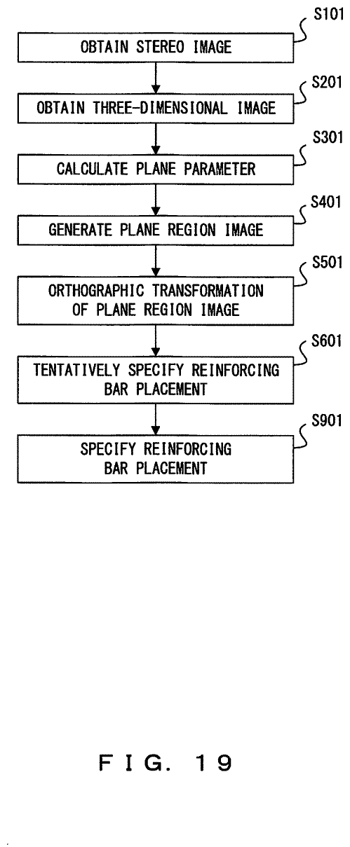

Next, a flow of processing of the reinforcing bar placement specifying function in the reinforcing bar placement angle specifying system 1 according to the second embodiment is explained in detail with reference to FIG. 19 to FIG. 27.

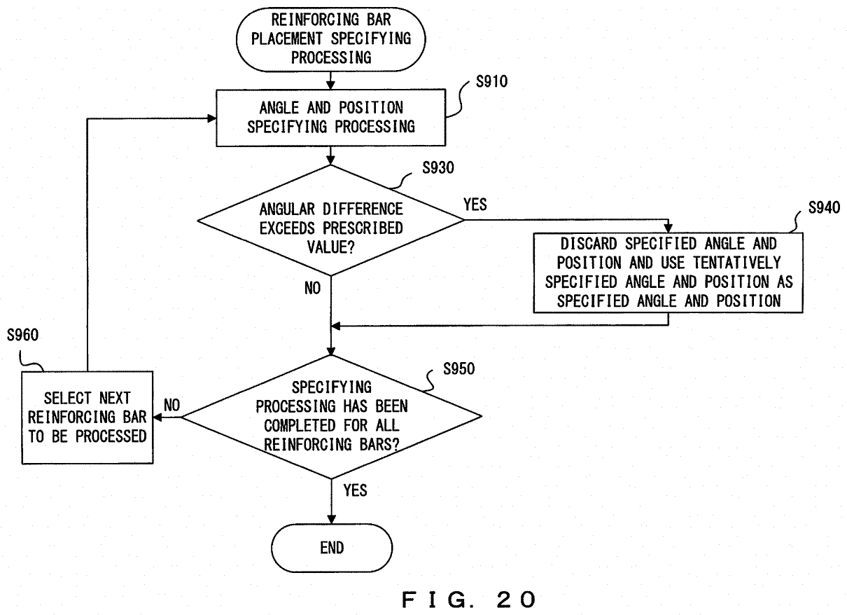

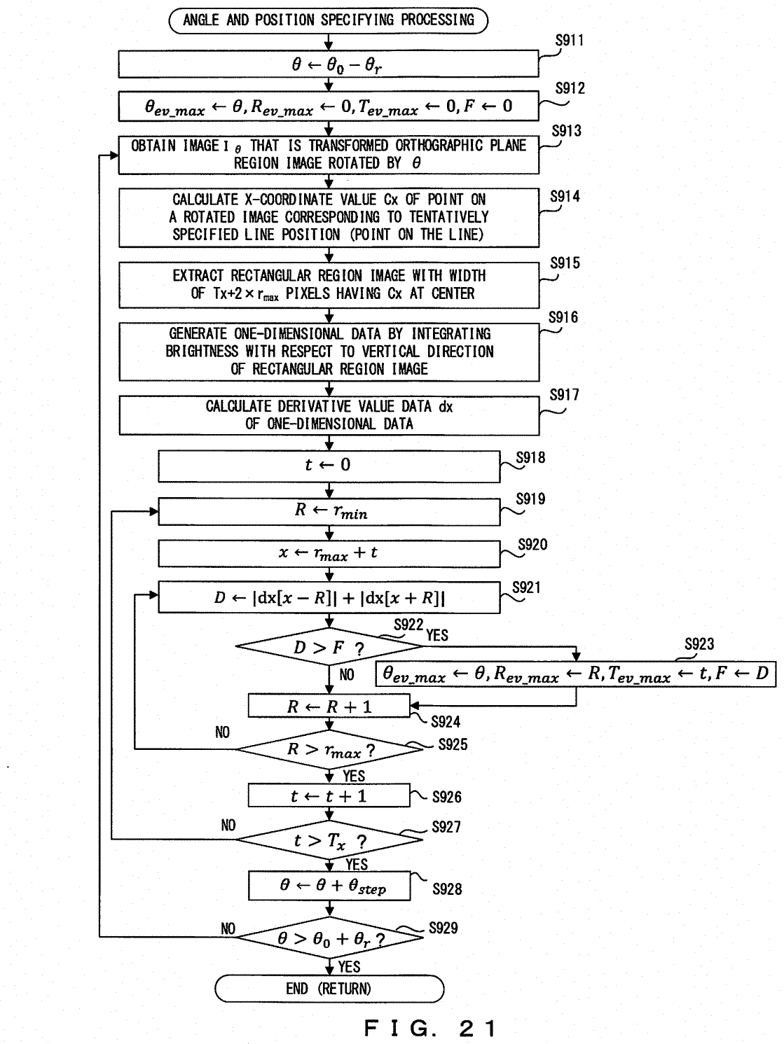

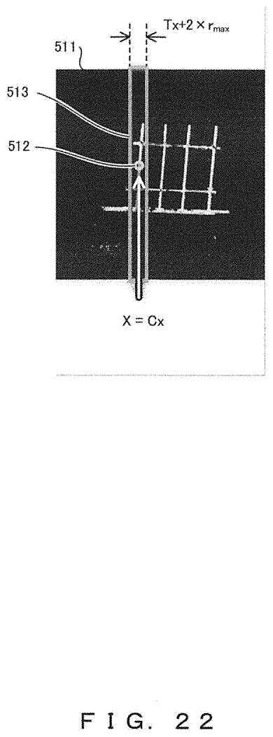

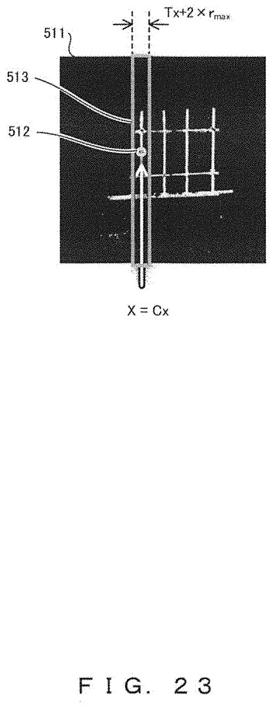

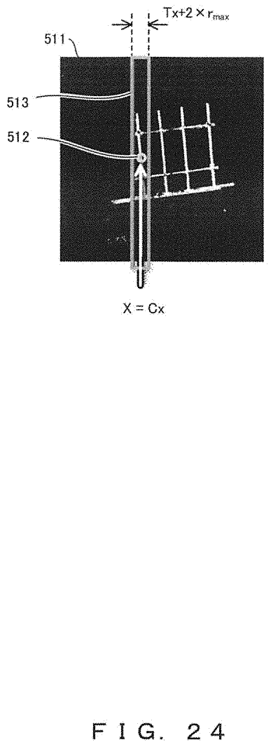

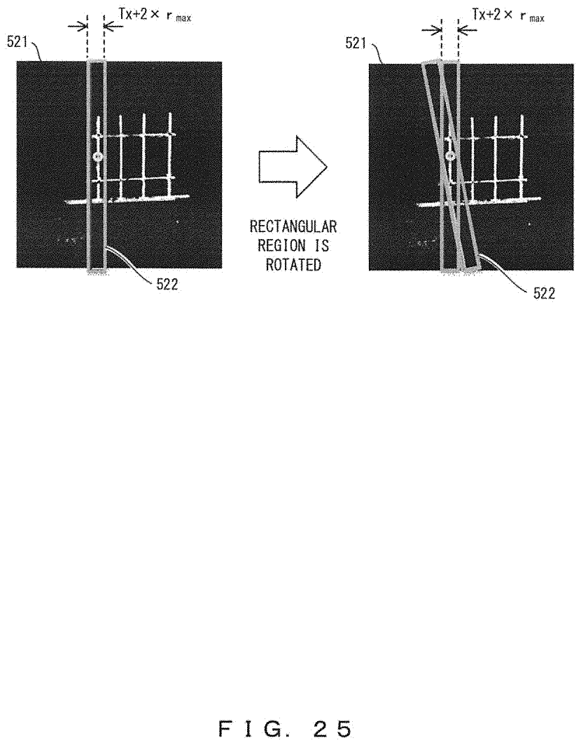

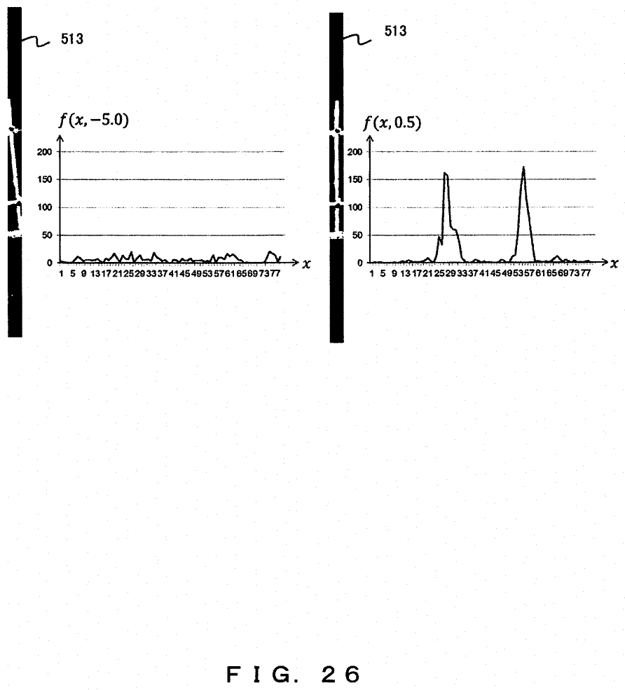

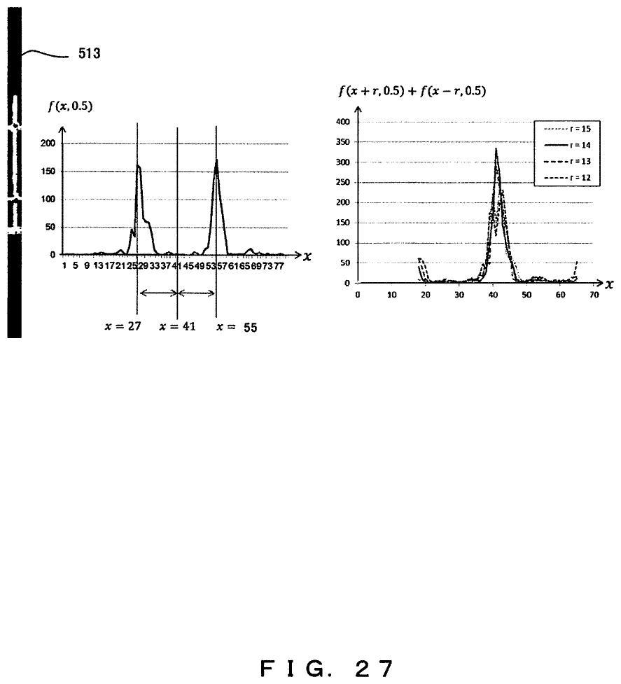

FIG. 19 is a flowchart illustrating an overall flow of the processing. FIG. 20 is a flowchart illustrating a flow of reinforcing bar placement specifying processing (step S901 described later). FIG. 21 is a flowchart illustrating a flow of processing to specify a placement angle and a placement position of a reinforcing bar (step S910 described later). FIG. 22, FIG. 23, and FIG. 24 are diagrams explaining an example of processing when the processing in step S913 to the processing in step S915, which are described later, are repeated. FIG. 25 is a diagram explaining an example of a modification of processing to extract a rectangular region image. FIG. 26 is a diagram illustrating an example of a graph plotting values of a function f, which is described later, at positions in the x-direction of a rectangular region image. FIG. 27 is a diagram illustrating an example in which the sum of values of the function f at two positions, which are described later, in the x-direction of the rectangular region image becomes the maximum.

As illustrated in FIG. 19, the processing of the reinforcing bar placement specifying function of the reinforcing bar placement angle specifying system 1 according to the second embodiment is different from the processing according to the first embodiment illustrated in FIG. 4 in such a point that the processing in S901 is performed instead of the processing in S701 and the processing in S801.

In other words, in the processing according to the second embodiment, after the processing in S101 to the processing in S601 as in the first embodiment, CPU 201 performs reinforcing bar placement specifying processing in S901 for obtaining reinforcing bar placement specifying information, which is more accurate placement information of reinforcing bars, based on the transformed orthographic plane region image obtained in step S501 and the reinforcing bar placement tentatively specifying information obtained in step S601.

Here, a detailed flow of the reinforcing bar placement specifying processing (step S901) is described with reference to FIG. 20. In the processing illustrated in FIG. 20, lines (axes of reinforcing bars) of which information of angles and positions is included in the reinforcing bar placement tentatively specifying information obtained in step S601 are processed, and for each of the lines to be processed, processing for specifying more accurate angle and position is repeated.

As illustrated in FIG. 20, in step S910, CPU 201 performs specifying processing of angles and positions that is processing for specifying more accurate angles and positions of lines to be processed from the transformed orthographic plane region image obtained in step S501 and the reinforcing bar placement tentatively specifying information obtained in step S601.

Here, a detailed flow of the specifying processing of angles and positions (step S910) is described with reference to FIG. 21. In the processing illustrated in FIG. 21, with respect to the lines to be processed, processing for calculating an evaluation value of brightness gradient and updating the maximum value is repeated every time search conditions (angles, positions, size) for specifying angle sand positions are changed.

As illustrated in FIG. 21, in step S911, similarly to step S811 in FIG. 6, CPU 201 specifies θ₀−θᵣ as a starting angle for an angle θ of a line. Here, θ₀ is an angle of a line to be processed that is included in the reinforcing bar placement tentatively specifying information obtained in step S601. θᵣ is a setting value within a search range of angle. According to this setting value, the search range is θ₀±θᵣ.

In step S912, CPU 201 initializes a variable F for updating the maximum value of an evaluation value of brightness gradient, a variable θ_{ev_max} for recording an angle at which the evaluation value becomes the maximum value, a variable R_{ev_max} for recording a radius at which the evaluation value becomes the maximum value, and a variable T_{ev_max} for recording a position at which the evaluation value becomes the maximum value. In other words, the variable F is set to 0, the variable θ_{ev_max} is set to θ, the variable R_{ev_max} is set to 0, and the variable T_{ev_maax} is set to θ.

In step S913, CPU 201 obtains a rotated image Ie that is obtained by rotating a transformed orthographic plane region image obtained in step S501 by the angle θ.

In step S914, CPU 201 obtains the x-coordinate value Cx on the rotated image I_{θ} obtained in step S913. The x-coordinate value corresponds to a position of a line to be processed. The position is included in the reinforcing bar placement tentatively specifying information obtained in step S601.

In step S915, CPU 201 extracts a rectangular region image with a width of Tx+2×rₘₐₓ pixels (a width on the rotated image I_{θ} in the x-direction) having the x-coordinate value Cx obtained in step S914 at the center. Here, Tx is a specified width and is 40 pixels for example. The values of rmax and rₘᵢₙ, which is described later, are setting values including the maximum value and the minimum value that define a search range of radius. Accordingly, the search range of radius is from rₘᵢₙ to rₘₐₓ. Note that the height of the rectangular region is the same as the height of the rotated image I_{θ}. This rectangular region is also an example of a region including a reinforcing bar corresponding to a line to be processed and a surrounding region of the reinforcing bar.

By repeating the above-described processing in step S913 to step S915, images of a rectangular region 513 illustrated in FIG. 22, FIG. 23, and FIG. 24 are extracted. Note that in each of FIG. 22, FIG. 23, and FIG. 24, the image 511 is a rotated image I_{θ} obtained in step S913. However, the angle θ when the transformed orthographic plane region image was rotated in step S913 is different for each of the images 511 in FIG. 22, FIG. 23, and FIG. 24 due to the processing in step S928 described later. In each of FIG. 22, FIG. 23, and FIG. 24, the point 512 indicates a point on the image 511 that corresponds to a position of a line to be processed and the position is included in the reinforcing bar placement tentatively specifying information obtained in step S601.

The x-coordinate value of the point 512 is Cx. The image of the rectangular region 513 is a rectangular region image extracted in step S915 and is a rectangular region image with a width of Tx+2×rₘₐₓ having the x-coordinate value Cx of the point 512 at the center.

In step S916, CPU 201 generates one-dimensional data by integrating a brightness value with respect to the vertical direction (y-direction) in the rectangular region image extracted in step S915. This one-dimensional data is data of an integral value of brightness values with respect to the vertical direction at each position in the lateral direction (x-direction) of the rectangular region image. Note that the vertical direction and the lateral direction of the rectangular region image are for example a vertical direction (y-direction) and a lateral direction (x-direction) of the image of the rectangular region 513 illustrated in FIG. 22, respectively.

In step S917, CPU 201 calculates derivative value data dx of the one-dimensional data generated in step S916. The derivative value data dx corresponds to the gradient of the sum of the brightness values.

In step S918, CPU 201 sets a value of a variable t, which is used to search for a position, to 0.

In step S919, CPU 201 sets a value of the variable R, which is used to search for a radius, to rₘᵢₙ.

In step S920, CPU 201 sets a value of a variable x, which is used to search for a position, to rₘₐₓ+t.

In step S921, CPU 201 calculates the sum of an absolute value of the derivative value data at a position x−R in the x-direction and an absolute value of the derivative value data at a position x+R in the x-direction based on the derivative value data dx calculated in step S917, and a value of the variable D is set to be a value obtained as a result of the calculation of the sum.

In step S922, CPU 201 determines whether a value of the variable D is larger than a value of the variable F or not. Here, when the determination result is YES, in step S923, CPU 201 updates a value of the variable θ_{ev_max} to the angle θ, updates a value of the variable R_{ev_max} to the variable R, updates a value of the variable T_{ev_max} to a value of the variable t, and updates a value of the variable F to a value of the variable D.

On the other hand, when the determination result in step S922 is NO, or after step S923, CPU 201 increments (+1) the value of the variable R in step S924.

In step S925, CPU 201 determines whether the value of the variable R is larger than rₘₐₓ or not. Here, the determination result is NO, the processing returns to S921.

On the other hand, when the determination result in step S925 is YES, CPU 201 increments the value of the variable t in step S926.

In step S927, CPU 201 determines whether the value of the variable t is larger than Tx (the specific width described above) or not. Here, when the determination result is NO, the processing returns to S919.

On the other hand, when the determination result in step S927 is YES, CPU 201 adds a step size θₛₜₑₚ to the angle e in step S928. For example, the step size θₛₜₑₚ is 0.5 degrees.

In step S929, CPU 201 determines whether the angle e exceeds the search range of angle (θ₀±θᵣ) or not. Here, the determination result is NO, the processing returns to step S913.

On the other hand, when the determination result in step S929 is YES, the processing returns.

According to the above-described processing illustrated in FIG. 21, a value of the variable θ_{ev_max} can be obtained as an angle of a line to be processed and the sum of a value of the variable T_{ev_max} and rmax can be obtained as a position of the line to be processed.

Note that in the processing illustrated in FIG. 21, a transformed orthographic plane region image is rotated and a rectangular region image is extracted at each angle within the search range. However, instead of rotating the transformed orthographic plane region image, a rectangular region may be rotated and an image of the rectangular region after the rotation may be extracted. For example, as illustrated in FIG. 25, instead of rotating the transformed orthographic plane region image 521, the rectangular region 522 is rotated and an image of the rectangular region 522 after the rotation (the rectangular region 522 in the transformed orthographic plane region image 521 on the right side) may be extracted.

When processing is expressed by using a formula, the processing illustrated in FIG. 21 is expressed as the following formula (6).

$${θ}^{′} , {r}^{′} , {x}^{′} = {{{argmax}_{{θ}_{o} - {θ}_{r} \leq θ \leq {θ}_{o} + {θ}_{r}}}_{{r}_{min} \leq r \leq {r}_{max}}}_{{c}_{x} - \frac{{T}_{x}}{2} \leq x \leq {c}_{x} + \frac{{T}_{x}}{2}} ( f ( x + r , θ ) + f ( x - r , θ ) ) \\ where f ( x , θ ) = \vert \frac{\partial \int {I}_{θ} ( x , y ) dy}{\partial x} \vert \qquad Formula ( 6 )$$

In the above formula (6), θ′ is θ_{ev_max} described above, r′ is R_{ev_max} described above, x′ is T_{ev_max}+rₘₐₓ, and r is R described above. Note that the description of the above formula (4) also applies to the function f. However, I_{θ} included in the function f in the above formula (6) represents an image that is a transformed orthographic plain region image rotated by θ.

Here, regarding the processing described in FIG. 21, additional descriptions are provided with a specific example.

In the rectangular region image extracted in step S915, when a line to be processed is parallel to an axis of the rectangular region image in the vertical direction (y-direction), a value of the function f becomes large at a position of an outline of a reinforcing bar in the rectangular region image.

For example, the graph on the left side of FIG. 26 is a graph plotting values of the function f at positions in the x-direction of the rectangular region image 513 illustrated in FIG. 24 (that is also a rectangular region image extracted from a transformed orthographic plane region image rotated by −5 degrees). The graph on the right side of FIG. 26 is a graph plotting values of the function f at positions in the x-direction of the rectangular region image 513 illustrated in FIG. 23 (that is also a rectangular region image extracted from a transformed orthographic plane region image rotated by 0.5 degrees). When the right side and the left side of FIG. 26 are compared with each other, the line to be processed is not parallel to the axis in the vertical direction in the rectangular region image 513 on the left side of FIG. 26. On the other hand, the line to be processed is parallel to the axis in the vertical direction in the rectangular region image 513 on the right side of FIG. 26. In the graph on the right side of FIG. 26, values of the function f are found to be large at the position of an outline of a reinforcing bar (a reinforcing bar corresponding to the line to be processed) in the rectangular region image 513.

Here, when two positions in the x-direction in a rectangular region image are represented by a midpoint (x) of the two positions and a distance (r) from the midpoint, the sum of values of the function f at the two positions can be represented as f(x+r, θ)+f(x−r, θ). The sum becomes the maximum when the value of x is a position of the axis of the reinforcing bar (line) in the rectangular image and the value of r is a position of an outline of the reinforcing bar in the rectangular region image. For example, in the example provided on the right side of FIG. 26, the sum of values of the function f (f(x+r, θ)+f(x−r, θ)) becomes the maximum when x=41 and r=14 as provided in FIG. 27. Note that the graph provided on the right side of FIG. 27 is a graph plotting the sum of values of the function f when x=41 and r is changed from 12 to 15. The sum of values of the function f appears to become the maximum at r=14.

With reference to FIG. 20, in step S930, CPU 201 determines whether an angular difference between an angle of a line to be processed, which is included in the reinforcing bar placement tentatively specifying information obtained in step S601, and an angle of a line to be processed, which is specified in step S910, exceeds a prescribed value (e.g., 3 degrees) or not. Note that this angular difference is expected to be equal to or less than a prescribed value when the angle of a line to be processed, which is specified in step S910, is correctly specified.

When the determination result in step S930 is YES, in step S940, CPU 201 discards the angle and the position of the line to be processed, which are specified in step S910. The angle and the position of the line to be processed, which is included in the reinforcing bar placement tentatively specifying information obtained in step S601, are used as the angle and the position of the line to be processed, which are specified in step S910. The reason that this processing is performed is that the angle and the position of the line to be processed, which is specified in step S910, may not be correctly specified.

When the determination result in S930 is NO, or after S940, in step S950, CPU 201 determines whether the processing in step S910 has been completed or not for all lines (reinforcing bars) of which information of angles and positions is included in the reinforcing bar placement tentatively specifying information obtained in step S601.

When the determination result in step S950 is NO, in step S960, CPU 201 selects a line that has not been processed from among the lines (reinforcing bars) of which information of angles and positions is included in the reinforcing bar placement tentatively specifying information as the next line to be processed, and the processing returns to step S910.

On the other hand, when the determination result in step S950 is YES, the processing ends.

As a result of the above-described processing, more accurate angles and positions of lines that are more accurate placement angles and placement positions of reinforcing bars are obtained as reinforcing bar placement specifying information.

Based on the reinforcing bar placement specifying information and the transformed orthographic plane region image obtained in step S501 as an example, CPU 201 performs processing to obtain (measure) reinforcement information such as the size, the intervals and the number of the reinforcing bars and processing to display and record the processing result.

As described above, according to the reinforcing bar placement angle specifying system 1 according to the second embodiment, like the first embodiment, placement angles and placement positions of plural reinforcing bars to be inspected can be specified with a high degree of accuracy, and based on the placement angles and placement positions, highly accurate reinforcement information such as the size, the intervals and the number of the reinforcing bars can be obtained. In addition to the placement positions, placement angles can also be specified by using a transformed orthographic plane region image. Therefore, only a transformed orthographic plane region image is needed as a transformed orthographic image used for specifying a placement angle and a placement position. Because a placement angle and a placement position are specified at the same time by using a transformed orthographic plane region image, overall processing time can be reduced. When specified placement angle and placement position may not be specified correctly, the angle and position are discarded and placement angle and placement position, which are tentatively specified, are used instead. Consequently, it is possible to prevent reinforcing bar placement specifying information with inappropriate placement angles and placement positions from being provided.

Note that in the second embodiment, the following modification may be made.

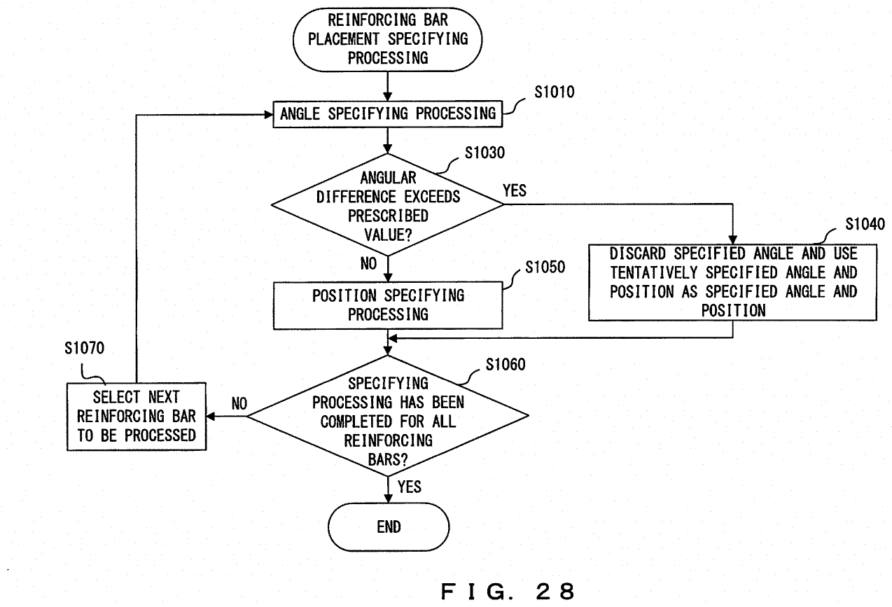

For example, the reinforcing bar placement specifying processing (step S901) may be modified as illustrated in FIG. 28. FIG. 28 is a flowchart illustrating a flow of reinforcing bar placement specifying processing (step S901) according to a modification example. The processing in FIG. 28 is different from the processing in FIG. 20 in such a point that angles and positions are specified by means of different types of processing.

As illustrated in FIG. 28, in step S1010, CPU 201 performs angle specifying processing for specifying a more accurate angle of a line to be processed on the basis of a transformed orthographic plane region image obtained in step S501.

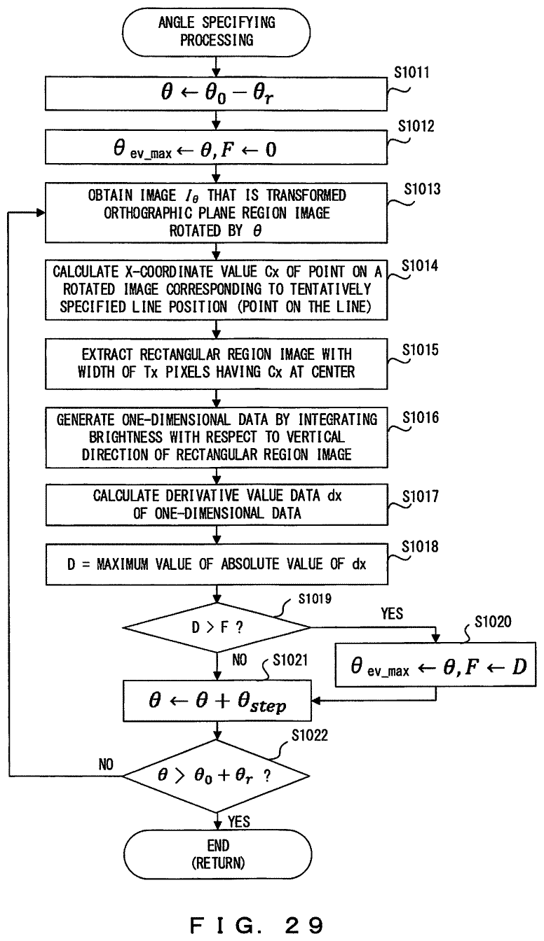

Here, a detailed flow of the angle specifying processing (step S1010) is described with reference to FIG. 29. FIG. 29 is a flowchart illustrating a flow of the angle specifying processing (step S1010). The processing illustrated in FIG. 29 is different from the processing illustrated in FIG. 6 in such a point that a transformed orthographic plane region image is used instead of a transformed orthographic image.

In other words, as illustrated in FIG. 29, in steps 51011 and S1012, CPU 201 performs processing similar to steps S811 and S812 in FIG. 6.

In step S1013, CPU 201 obtains a rotated image Ie that is a transformed orthographic plane region image rotated obtained in step S501 by an angle θ.

From step S1014 to step S1022, CPU 201 performs processing similar to processing from step S814 to step S822 in FIG. 6.

With reference to FIG. 28, in step S1030, similarly to step S930 in FIG. 20, CPU 201 determines whether an angular difference between an angle of a line to be processed, which is included in the reinforcing bar placement tentatively specifying information obtained in step S601, and an angle of a line to be processed, which is specified in step S1010, exceeds a prescribed value (e.g., 3 degrees) or not.

When the determination result in step S1030 is YES, in step S1040, CPU 201 discards the angle and the position of the line to be processed, which are specified in step S1010. The angle and the position of the line to be processed, which is included in the reinforcing bar placement tentatively specifying information obtained in step S601, are used as the angle of the line to be processed, which is specified in step S1010, and a position of the line to be processed, which is specified in step S1050 described later.

When the determination result in S1030 is NO, in step S1050, CPU 201 performs position specifying processing for specifying a more accurate position of a line to be processed on the basis of a transformed orthographic plane region image, which is obtained in step S501, and an angle of the line to be processed, which is obtained in step S1010. A detailed flow of the position specifying processing (step S1030) is the same as the flow of processing in FIG. 7, and therefore the description is omitted here.

After step S1040, or after step S1050, CPU 201 performs determination processing that is the same as the processing in S950 in FIG. 20 in step S1060. Here, when the determination result is NO, CPU 201 performs processing that is the same as the processing in S960 in FIG. 20 in step S1070, and the processing returns to step S1010.

On the other hand, when the determination result in step S1060 is YES, the processing ends.

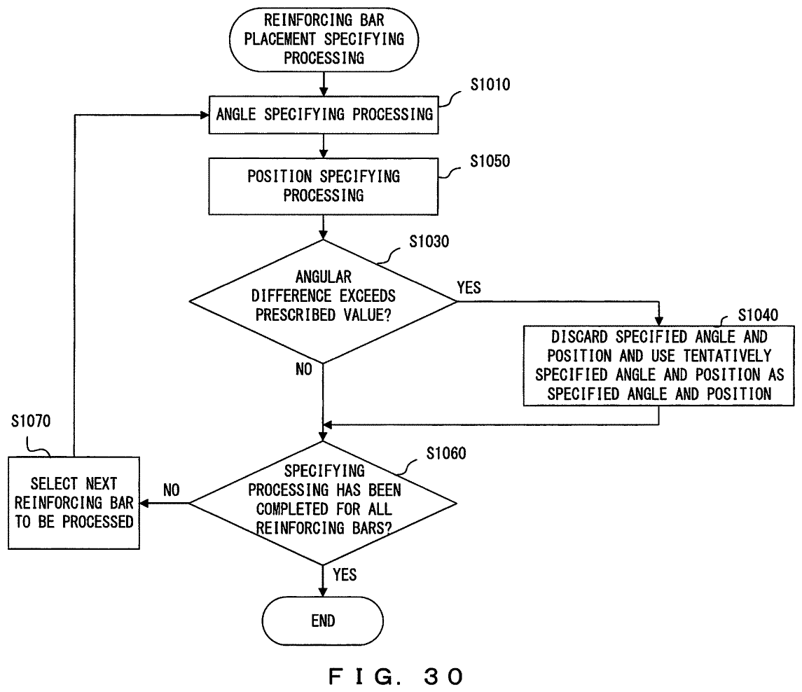

The above-described reinforcing bar placement specifying processing (step S901) in FIG. 28 may be further modified as illustrated in FIG. 30. FIG. 30 is a flowchart illustrating a flow of reinforcing bar placement specifying processing (step S901) according to another modification example.

The processing in FIG. 30 is different from the processing in FIG. 28 in such a point that the position specifying processing (step S1050) is performed after the processing in step S1010 and before the determination processing in step S1030. Due to this modification, in step S1040, CPU 201 discards the angle of the line to be processed, which is specified in step S1010, and the position of the line to be processed, which is specified in step S1030. The angle and the position of the line to be processed, which is included in the reinforcing bar placement tentatively specifying information obtained in step S601, are used as the angle of the line to be processed, which is specified in step S1010, and the position of the line to be processed, which is specified in step S1050.

In the processing in FIG. 30, the other processing is the same as the processing in FIG. 28.

In the above description, the first and second embodiments are explained. Each of the embodiments may be further modified as below.

In the first embodiment, the reinforcing bar placement specifying processing in FIG. 5 (step S801) may be modified to be the reinforcing bar placement specifying processing in FIG. 28 or FIG. 30 (step S901). In other words, in the processing in FIG. 5, the determination processing in step S1030 of FIG. 28 is performed after the processing in step S810 and before the processing in step S830. When the determination result is YES, the processing proceeds to step S840 after the processing in step S1040 of FIG. 28, and when the determination result is NO, the processing proceeds to step S830. Alternatively, in the processing in FIG. 5, the determination processing in step S1030 of FIG. 30 is performed after the processing in step S830 and before the determination processing in step S840. When the determination result is YES, the processing proceeds to step S840 after the processing in step S1040 of FIG. 30, and when the determination result is NO, the processing proceeds to step S840.

Each of the embodiments may also correct plane parameters based on the reinforcing bar placement specifying information obtained in step S801 (see FIG. 4) or step S901 (see FIG. 19) described above in order to further enhance the degree of accuracy of the size and the intervals of reinforcing bars obtained as reinforcement information. Correcting plane parameters also means correcting positions and inclinations of the plane detected in step S301 described above. This means that despite the assumption that a transformed orthographic image is parallel to a three-dimensional plane, when an image has some deviation, the deviation is corrected. The size and intervals of reinforcing bars measured on a transformed orthographic image (a transformed orthographic image or a transformed orthographic plane region image) are affected by a position and inclination of a plane represented by a plane equation of calculated plane parameters. By correcting the plane parameters, the size and intervals of reinforcing bars to be measured can be corrected.

Correction of plane parameters is performed, for example, by a numerical-analytical operation through a flow of the following processing from step S1101 to step S1105. Aside from the numerical-analytical operation, by correcting by a geometric operation, a state in which reinforcing bars are most parallel to each other may be calculated. Note that this processing is performed by CPU 201.

In step S1101, the normal vector to a plane detected in step S301 described above (a plane represented by the plane equation of plane parameters calculated in step S301) is modified at a predetermined fine angle within a predetermined range.

In step S1102, a starting point and an ending point of a reinforcing bar (coordinates on a transformed orthographic image or a transformed orthographic plane region image) based on the reinforcing bar placement specifying information obtained in step S801 or step S901 described above are projected onto the plane with the normal vector modified in step S1101.

In step S1103, dispersion of angles of vectors formed by projected points on the plane corresponding to the reinforcing bar is calculated for each of the vertical direction and the lateral direction.

In step S1104, steps 51101 to 51103 are repeated until a predetermined range is completed.

In step S1105, plane parameters of the normal vector when the dispersion calculated in step S1103 is the smallest (plane parameters in a plane equation representing a plane of the normal vector) are used as corrected plane parameters.

In this manner, the plane parameters are corrected.

In each of the embodiments, an image and a three-dimensional image of the same viewpoint obtained by the stereo camera 10 may be input to the terminal device 20 via the portable recording medium 206 for example. In this case, the image and the three-dimensional image of the same viewpoint obtained by the stereo camera 10 are recorded in the portable recording medium 206, and afterwards the portable recording medium 206 is loaded into the portable recording medium driver 205, and the image and the three-dimensional image of the same viewpoint are read out of the portable recording medium 206 to carry out the processing.

Alternatively, the image and the three-dimensional image of the same viewpoint obtained by the stereo camera 10 may be input to the terminal device 20 over a network configured of one or both of wired and wireless networks. In this case, each of the stereo camera 10 and the terminal device 20 has a network interface device, and an image and a three-dimensional image of the same viewpoint are transmitted/received over a network to carry out the processing.

In each of the embodiments, programs executed by CPU 201 of the terminal device 20 may be provided over a network from an external device connected to the network. In this case, the terminal device 20 has a network interface device and programs are provided from the external device over the network.

In each of the embodiments, at least the configurations that includes functional blocks illustrated in FIG. 3 or FIG. 18 of the reinforcing bar placement angle specifying system may be implemented by a single device, or may be implemented by plural devices that is not limited to a combination of the stereo camera 10 and the terminal device 20.

As described above, the embodiments has such an advantageous effect that a placement angle of each of plural reinforcing bars to be inspected can be specified with a high degree of accuracy.

Note that the embodiments are not limited to the above-described embodiments per se, but the components may be modified and embodied without departing from the scope. Various embodiments can be formed by proper combinations of multiple components disclosed in the above-described embodiments. For example, some of the components in the embodiments may be eliminated. Furthermore, components in different embodiments may be properly combined.

What is claimed is:

1. A reinforcing bar placement angle specifying method, comprising:
obtaining an image of a plurality of placed reinforcing bars;
generating an orthographic image of a reinforcing bar placed on a plane from among the plurality of placed reinforcing bars based on the image;
tentatively specifying a placement state of the reinforcing bar placed on the plane by analyzing the orthographic image; and
specifying a placement angle of the reinforcing bar for each reinforcing bar of which the placement state is tentatively specified.

2. The reinforcing bar placement angle specifying method according to claim 1, comprising:
for each reinforcing bar of which the placement state is tentatively specified,
extracting a region including the reinforcing bar and a surrounding region of the reinforcing bar;
calculating a brightness gradient of the extracted region at each of a plurality of different rotation angles; and
specifying the placement angle of the reinforcing bar based on a rotation angle at which the brightness gradient becomes maximum.

3. The reinforcing bar placement angle specifying method according to claim 1, comprising:
generating a three-dimensional image of a same viewpoint as the image based on the image;
generating the orthographic image from each of the image and the three-dimensional image;
tentatively specifying a placement state of the reinforcing bar placed on the plane by analyzing the orthographic image generated from the three-dimensional image; and
specifying a placement angle of the reinforcing bar for each of reinforcing bars of which a placement state is tentatively specified by analyzing the orthographic image generated from the image based on the placement state.

4. The reinforcing bar placement angle specifying method according to claim 3, comprising:
for each reinforcing bar of which the placement state is tentatively specified,
extracting a region including the reinforcing bar and a surrounding region of the reinforcing bar from the orthographic image generated from the image based on the placement state;
calculating a brightness gradient of the extracted region at each of a plurality of different rotation angles; and
specifying the placement angle of the reinforcing bar based on a rotation angle at which the brightness gradient becomes maximum.

5. The reinforcing bar placement angle specifying method according to claim 1, comprising:
specifying a placement position of the reinforcing bar at a placement angle of the reinforcing bar for each of the reinforcing bars of which the placement angle is specified.

6. The reinforcing bar placement angle specifying method according to claim 3, comprising:
specifying a placement angle of the reinforcing bar for each of reinforcing bars of which a placement state is tentatively specified by analyzing the orthographic image generated from the three-dimensional image based on the placement state.

7. The reinforcing bar placement angle specifying method according to claim 6, comprising:
for each reinforcing bar of which the placement angle is specified,
extracting a region including the reinforcing bar and a surrounding region of the reinforcing bar from the orthographic image generated from the three-dimensional image based on the placement angle;
obtaining brightness information of the extracted region in a direction that is set in accordance with the placement angle of the reinforcing bar; and
specifying a placement position of the reinforcing bar based on the brightness information.

8. The reinforcing bar placement angle specifying method according to claim 1, comprising:
generating a three-dimensional image of a same viewpoint as the image based on the image;
generating the orthographic image from the three-dimensional image;
tentatively specifying a placement state of the reinforcing bar placed on the plane by analyzing the orthographic image; and
specifying a placement angle of the reinforcing bar for each of reinforcing bars of which a placement state is tentatively specified by analyzing the orthographic image based on the placement state.

9. The reinforcing bar placement angle specifying method according to claim 8, comprising:
specifying a placement angle of the reinforcing bar and a placement position of the reinforcing bar for each of the reinforcing bars of which the placement state is tentatively specified by analyzing the orthographic image based on the placement state.

10. The reinforcing bar placement angle specifying method according to claim 8, wherein
the orthographic image is a binary image.

11. The reinforcing bar placement angle specifying method according to claim 1, comprising:
for each reinforcing bar of which the placement state is tentatively specified,
specifying a placement angle of the reinforcing bar;
determining whether an angular difference between the specified placement angle of the reinforcing bar and the placement angle of the reinforcing bar in the tentatively-specified placement state of the reinforcing bar is larger than a prescribed value; and
specifying the placement angle of the reinforcing bar in the tentatively-specified placement state of the reinforcing bar as the placement angle of the reinforcing bar when the angular difference is determined to be larger than the prescribed value.

12. A reinforcing bar placement angle specifying system, including an arithmetic device that executes processing, the processing comprising:
obtaining an image of a plurality of placed reinforcing bars;
generating an orthographic image of a reinforcing bar placed on a plane from among the plurality of placed reinforcing bars based on the image;
tentatively specifying a placement state of the reinforcing bar placed on the plane by analyzing the orthographic image; and
specifying a placement angle of the reinforcing bar for each reinforcing bar of which the placement state is tentatively specified.

13. A non-transitory computer-readable recording medium recording a reinforcing bar placement angle specifying program that causes a computer to execute processing, the processing comprising:
obtaining an image of a plurality of placed reinforcing bars;
generating an orthographic image of a reinforcing bar placed on a plane from among the plurality of placed reinforcing bars based on the image;
tentatively specifying a placement state of the reinforcing bar placed on the plane by analyzing the orthographic image; and
specifying a placement angle of the reinforcing bar for each reinforcing bar of which the placement state is tentatively specified.
